(19) United States
(12) Patent Application Publication
(10) Pub. No.: US 2006/0098593 A1
(43) Pub. Date: May 11, 2006

(54) Open access network architecture

(76) Inventors: Einar Paul Edvardsen, Sorum (NO); Nils Holte, Trondheim (NO)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/530,701

(22) PCT Filed: Oct. 9, 2003
(86) PCT No.: PCT/NO03/00339

§ 371 Date: Sep. 15, 2005

(30) Foreign Application Priority Data
Oct. 11, 2002 (NO) 20024923

(51) Int. Cl. H04Q 7/00

(52) U.S. Cl. 370/328

(57) ABSTRACT

The invention provides a method and network architecture providing a public, wireless broadband mobile service. The fixed, broadband access network is upgraded by installing home network means at subscriber premises of said fixed network. The home network means comprising at least a wireless local area network (wireless LAN) and a broadband access line to the fixed broadband network, wherein the wireless LAN functions as an access medium for casual passing mobile terminals and for wireless terminals and devices of said fixed subscribers and the broadband access line provides public access to the fixed, broadband network. A home netwoek unit is also described.

The present invention addresses architectural issues related to methods of enabling countrywide coverage for broadband mobile communication based upon existing network resources.

### TECHNICAL BACKGROUND

Mobile networks are today based upon a combination of wireless (radio) and fixed network infrastructures. The wireless part is the network part people have in mind while communicating with their mobile telephones. This part of the connection does only reach between their wireless terminals and the base station located up to a few kilometres away (GSM). The rest of the connection is established through the fixed network, which may be composed of any kind of fixed network infrastructures (copper cables, optical fibre cables, radio links, etc). Since the “air is free of charge”, most of the costs connected to establishing a mobile network is therefore connected to the establishment of the backbone network (or the feeder network), i.e. the fixed network mentioned above.

Another aspect of mobile communication is connected to the number of users and the bandwidth offered to each of them. Each base station is only able to provide a limited number of users the requested bandwidth. If the demand for bandwidth is higher than the traffic capacity of one base station, the number of base stations must be increased. However, since the frequency spectrum, which is dedicated for mobile communication is limited, new base stations cannot easily be established without reusing frequency bands already used by other and often vicinal located base stations. Therefore one may risk that a geographical area is covered by more than one base station using the same frequency band, i.e introducing interference. The interference problem can be solved by locating each base station optimally with respect to each other dependent on the distance between them, influence of topology, antenna directivity and also tuning the output power from each base station to a level that does not disturb other base stations.

The problems mentioned above are particularly relevant in the discussion of establishing UMTS (Universal Mobile Telecommunication System) networks because the number of UMTS base stations compared to the corresponding number of GSM base stations, will be much higher and consequently make the above problems even more severe.

In order to provide mobile broadband capacity, a very dense feeder network must be established to feed the thousands of base stations with sufficient bandwidth. Each of these base stations will possibly cover less than a square kilometre. Countrywide coverage is therefore unrealistic in the short-term, and it is more popular to talk about “hot-spots” instead of a complete coverage, i.e. broadband base stations located at public places, corporate areas or similar where people may connect their mobile communication devices like computers (PC), mobile phones, personal digital devices (PDA) to the network. The term “A public broadband mobile network” or 4^{th} generation mobile systems beyond UMTS may therefore be considered as something that may be offered in some distant future due to the investment related to establishing the required feeder network.

At the present time there does not exist cheap alternatives or strategies for how to establish countrywide and public broadband mobile networks without having to build dense feeder networks. Large infrastructures will have to be built.

The traditional network architecture together with some other related ideas/technologies are explained and visualised in the sub-sections below.

The Traditional Architecture

This architecture is well known from all legacy wireless networks. To establish a broadband network, optical cables or radio links are the only realistic transmission media to be used. In order to connect all base stations, each located only 0.5-1 km from each other, huge infrastructures will therefore have to be established. The work to establish these has barely begun.

FIG. 1 shows how a person-to-person connection is established in a traditional mobile network. Only the “local parts”, i.e. the section from the user to the nearest base station is wireless. When a mobile terminal 4a, enters the coverage zone 16, of a base station 1, the terminal is automatically recognized and authenticated by location servers 21 in order to maintain updated records of the instantaneous locations of all terminals allowed to perform communication in the network. To establish communication between the two terminals 4a and 4b, in FIG. 1, each package of data sent between them in an IP (Internet Protocol) network, must contain the complete destination address. This destination address is detected in the network by IP routers, which transfer the data packet to the next one until it reaches the destination user. In an ATM (Asynchronous Transfer Mode) network a communication path through a number of ATM switches (the network) is set up first. All data packages relevant to this communication session are then sent along this path. Even in the case where two users located within the same radio zone are communicating with each other, the connection between the two users will be established from a terminal 4a, over a base station 1, over the feeder line 6, through a switch/router 22, and back again over the same feeder line 3, the same base station 1, and to the second terminal 4c.

The terms P2P and Ad Hoc are interpreted as being protocols that make it possible to establish self-organizing networks of communication devices such as computers (PCs, laptops) mobile phones, personal digital assistants (PDA), printers, storage devices, etc. and making them able to communicate with each other directly. The various devices may in principle be wired together, but the terms are today often associated with short-haul wireless communication. Compared to a traditional data network (client/server) where a client always communicates via the server with the other devices, central servers do not exist in pure P2P and Ad Hoc networks.

Ad Hoc protocols perform routing algorithms to establish a route from the originator to the destination without any initial knowledge about where to find the addressee. Examples of protocols are Bluetooth and various IETF (Internet Engineering Task Force) routing protocols.

P2P protocols run on the top of IP protocols and enable self-organization of communicating devices connected to an IP network. P2P is today in widely use, applications and protocols for sharing of, for instance mp3 files. In order to establish communication in a P2P network, all devices must run the same P2P protocols and application.

Both Ad Hoc and P2P networks will normally have some kind of connection to the legacy network in order to reach more customers.

An example of such a network is shown in FIG. 2 where four wireless devices, a Laptop (23), a printer (24), a PDA (25) and a music storage device (26) are connected wireless together. The printer (24) has a wireless connection to the WLAN base station with access to the core network (1) via the access line (3). It is implicitly understood that the reach of each device is limited to the nearest neighbouring device. One scenario of utilisation is that the PC (23) is connected to Internet (6), but since the PC is outside the reach of 1, the signals are relayed via 26, 24 and 1. The PC (23) may also use the printer via 26 or 25 at the same time as the PDA (25) has access to the Microsoft Outlook calendar, which is running on the PC (23). Other scenarios can also be drawn.

Hot-Spots

Wireless LAN has become a cheap and popular technology presently. The idea of building nationwide networks of hot-spots is a trend-in-time at the present. For instance, traditional mobile operators are presently establishing interconnection of hot-spots by integrating WLAN base stations with their GSM base stations, see FIG. 3, which depicts a GSM base station (18) and a wireless LAN base station (1) installed in the same location and their respective coverage zones 16 and 17. A mobile user with a PC with WLAN interface card (23) is crossing the zones along the dotted arrow. Inside the coverage zone of the wireless LAN (17) he is communicating with the Internet over base station 1 and the access line 3. When the user is leaving coverage zone 17 while still being within the coverage zone 16, the user's PC detects loss of wireless LAN signal and presence of GSM signal, after which his connection to the Internet (6) is transferred to the GSM network.

Another initiative worth mentioning is the Project Rainbow formed by Intel, IBM, AT&T Wireless, Verizon Communication and Cingular Wireless, who also plan to create nation-wide networks of hot-spots for Internet access.

In both cases will the feeder networks be realised in a traditional manner with dedicated lines/connections to the base stations.

### SUMMARY OF THE INVENTION

The objective of the invention is to enable broadband mobile communication over the fixed broadband access network infrastructure by offering the subscribers of the fixed broadband network wireless LANs that are connected to the fixed broadband network via Home Network Units. The Home Network Units function as interconnection units between the public broadband network and the wireless sphere provided by the wireless LANs.

According to a first aspect the invention provides a method of providing a public, wireless broadband mobile service by upgrading a fixed, broadband access network comprising installing home network means at subscriber premises of said fixed network, the home network means comprising at least a wireless local area network (LAN) and a broadband access line to the fixed broadband network, wherein the wireless LAN functions as an access medium for casual passing mobile terminals and for wireless terminals and devices of said fixed subscribers.

In an embodiment the bandwidth of the wireless LAN and the broadband access line of a fixed subscriber may be divided into respectively at least two separate channels, wherein a first channel is used by the fixed subscriber and a second channel is made available for the casual passing mobile terminals. The at least two channels may be dynamically dimensioned dependent on the fixed subscriber's instantaneous traffic in the wireless LAN and over the broadband access line, wherein the remaining bandwidth is made available for passing mobile terminals. The remaining bandwidth/second channel may include the portion of the physical realisable bandwidth not subscribed for by the fixed subscribers, the portion of the bandwidth subscribed for, but instantaneously unused by the fixed subscriber and the bandwidth that may be released due to priority mechanisms implemented in the network.

The home network means and the broadband access network may perform security and authentication functions securing the fixed subscriber and the passing mobile terminals against tapping and illegal use of said broadband network. Protocols in the home network means and in said fixed network may also be provided for performing mobility, handover and roaming procedures.

In a second aspect the invention provides a digital, mobile broadband network providing public mobile or nomadic broadband services based on an existing fixed, broadband access network with a number of subscribers possessing a home network means comprising at least a wireless local area network (LAN) and a broadband access line to a public, fixed broadband network, wherein the wireless LAN functions as an access medium for casual passing mobile terminals as well as for local wireless terminals of the fixed subscriber.

In an embodiment the bandwidth of the wireless LAN and the broadband access line is divided in at least two separate channels, a first channel being used by the subscriber and a second channel publicly available for the casual passing mobile terminals. The at least two channels may be dynamically dimensioned dependent on instantaneous traffic for the fixed subscriber in the wireless LAN and over the broadband access line. The remaining bandwidths of the said wireless LAN and access line are made available for the passing mobile terminals.

The channel for passing mobile terminals may in an embodiment comprise the portion of the physical realisable bandwidth not subscribed for by the fixed subscriber, the portion of the subscribed bandwidth not instantaneously used by the fixed subscriber and the bandwidth released due to the priority mechanisms implemented in the network. Security and authentication functions securing the fixed subscriber and the passing mobile terminals against tapping and illegal use of said broadband network may be performed by the home network means and/or by the broadband network. The home network means and said fixed broadband access network include protocols for performing mobility, handover and roaming procedures.

In a third aspect the invention provides a home network device providing public mobile or nomadic broadband services in an existing fixed, broadband access network comprising a number of subscribers. The device comprising: a wireless LAN providing local, wireless broadband communication for a subscriber of the fixed, broadband access network and broadband communication for passing mobile terminals; a broadband access line connected to the fixed broadband access network, and appropriate traffic and control functions needed for wireless mobile communication.

The home network device may in a further embodiment include a resource management system and multiplexer means dividing a physical available bandwidth of the wireless LAN and the broadband access line into at least two channels, a first channel to be used by the subscriber and a second public channel available for the casual passing mobile terminals. A resource management system may be implemented to perform dynamical bandwidth allocation to the casual passing mobile terminals dependent on the fixed subscriber's instantaneous traffic load on the wireless LAN and over the broadband access line. Switching/routing means may also be included in the home network unit for passing traffic to and from the broadband access network and the different wireless terminals located within the reach of the wireless LAN. Protocol means provides seamless mobility and handover procedures for maintaining the connection to the fixed broadband access network for a mobile terminal passing subscriber wireless LANs. The protocol means may provide roaming between different fixed, network operators, P2P/Ad-Hoc operators and individual subscriber LAN. Further, functions/program means supporting the broadband network's management and charging requirements may also be included in the home network unit.

In a further aspect the invention provides use of a home network device comprising at least a wireless LAN and a subscriber's broadband access line to a public broadband access network providing local wireless communication for the fixed subscriber and mobile broadband services to casual passing wireless terminals.

The above is summarized as follows:
1. Enabling the unused bandwidth of privately managed wireless LANs available for public use to access the fixed broadband network.
2. Building a broadband feeder network for the above wireless LANs, by utilising the unused bandwidth of the subscribers'broadband access lines to the fixed broadband network. This unused bandwidth may consist of
   a. Bandwidth not subscribed for by the above subscribers
   b. The part of the bandwidth subscribed for, but not momentarily used by the subscribers
   c. Bandwidth that possibly can be released following priority mechanisms implemented in the network.
3. Introducing a Home Network Unit at the premises of the fixed broadband network's subscribers, which functions as a bridge between the wireless LAN and the broadband access line and adds the necessary network functionality to the concept that shall enable seamless mobility, hand-over, resource management, switching and routing, quality of service guarantees, security, authentication and charging features.

As the invention partly relies on infrastructure that already exists or will be established for other purposes, the invention represents a path-breaking new approach to establishing networks for mobile broadband communication, compared to the traditional method as explained above.

An additional aspect of the invention is the possibility to include wireless Ad Hoc and peer-to-peer protocols into the concept. These technologies will enhance the concept by tying together wireless zones and making them connected through shared, spontaneous or on-demand use of fixed access lines. Hence, fewer base stations are needed to reach full coverage of a geographical area.

Compared to hot-spots, a popular business idea of today, the invention brings in the idea of providing exclusive feeder capacity to hot-spot base stations over the existing subscribers' access lines to the public broadband network. The above described traffic management and control functions will ensure communication quality. During time, while the number of base stations increases and forms dense and overlapping areas, the network will evolve towards the Open Access Network as described by this invention.

The main objective of P2P and Ad Hoc networks, as explained above, is to establish self-configuring wireless communication between wireless devices. P2P and Ad Hoc networks, however, do not address the objective of establishing infrastructures (feeder networks) for wireless broadband networks in other ways than persuading the users of the P2P and Ad Hoc networks to offer the subscribed part of the public access lines' capacity to the disposal for other P2P and Ad Hoc users. The un-subscribed part of the bandwidth of the fixed broadband access line is neither accessible for the fixed network's subscribers nor for other members of the P2P and Ad Hoc user groups. It is therefore impossible for them to establish networks based upon these resources.

By utilising mobile Ad Hoc and peer-to-peer protocols in a new, innovative network architecture, great advantages may be achieved. The apparent size of the wireless zones may be increased substantially. Each mobile device inside the zone will act as a new base station and add its own coverage zone to the rest, thus the distance reachable from a Home Network Unit will increase and accordingly drain more traffic into the fixed broadband network. Such Ad Hoc networks based upon a diversity of mobile devices may cover areas including more than one fixed line subscriber, thus a number of broadband access lines may be accessible for Ad Hoc users. Since all these access lines provide public broadband access, the Ad Hoc users will have the choice to select the one, which is performing best according to his requirement as regards capacity, quality and price.

### BRIEF DESCRIPTION OF DRAWINGS

Embodiments of the invention will now be described with reference to the following drawings, in which:

FIG. 1 illustrates communication in a traditional mobile network,

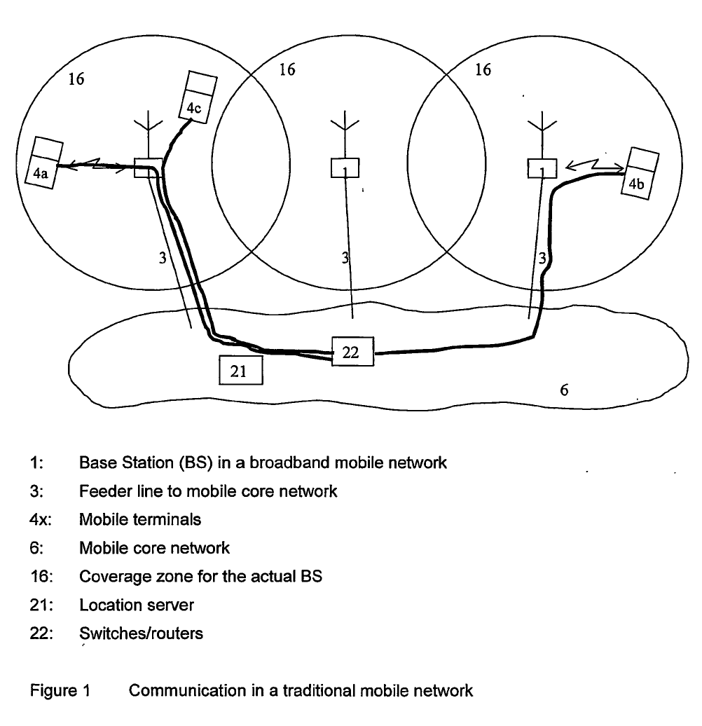

FIG. 2 shows an Ad Hoc/P2P network with connection to a legacy network over a broadband access line,

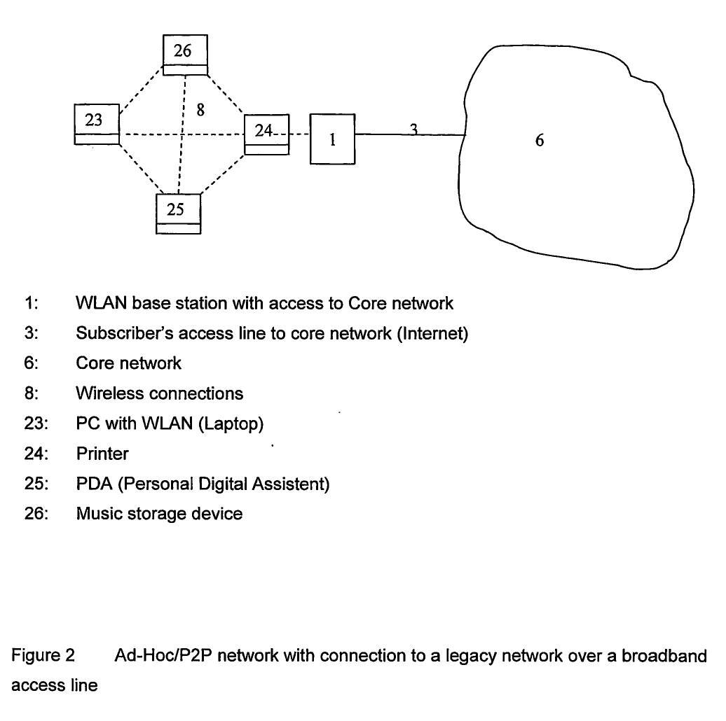

FIG. 3 shows a GSM base station with wireless LAN,

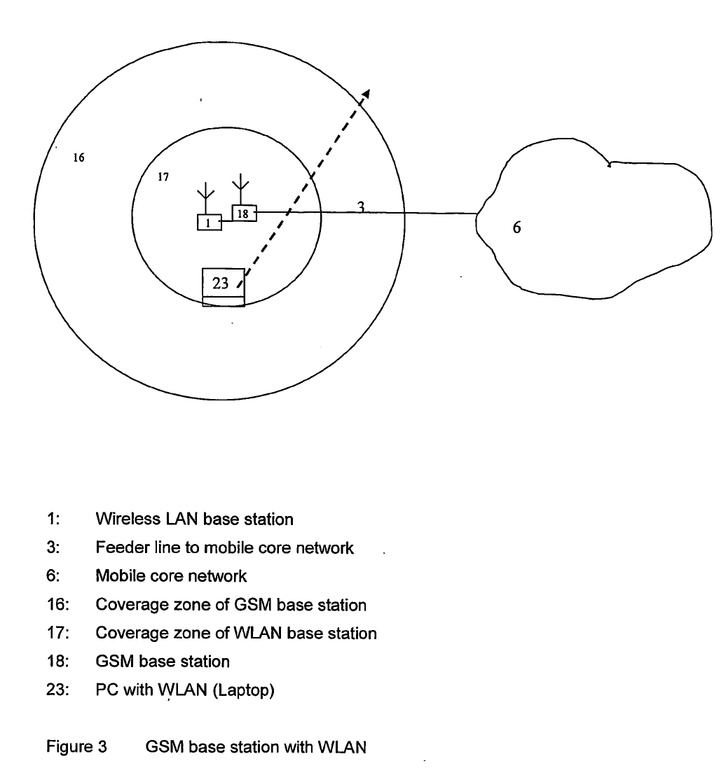

FIG. 4 illustrates a network with mobile broadband services according to an embodiment of the invention,

FIG. 5 is a schematic drawing of the main components of a network according to an embodiment of the invention,

FIG. 6 is a block diagram of the functionalities of a Home Network Unit according to an embodiment of the invention, and

FIG. 7 is a scenario description similar to FIG. 5, but enhanced with the functionality modules of the Home Network Unit.

### DETAILED DESCRIPTION

The main objective of the invention is to enable broadband mobile communication over the fixed broadband access network infrastructure by offering the subscribers of the fixed broadband network wireless LANs that are connected to the fixed broadband access line via Home Network Units. The Home Network Units perform the routing/switching and traffic functions that are needed to bridge traffic over the subscriber's broadband access line and wireless LAN and to provide public access for the mobile users over these wireless LANs. The communication from respectively the fixed subscriber and the casual passing mobile user is transferred over two separate channels in order to comply with security and privacy requirements.

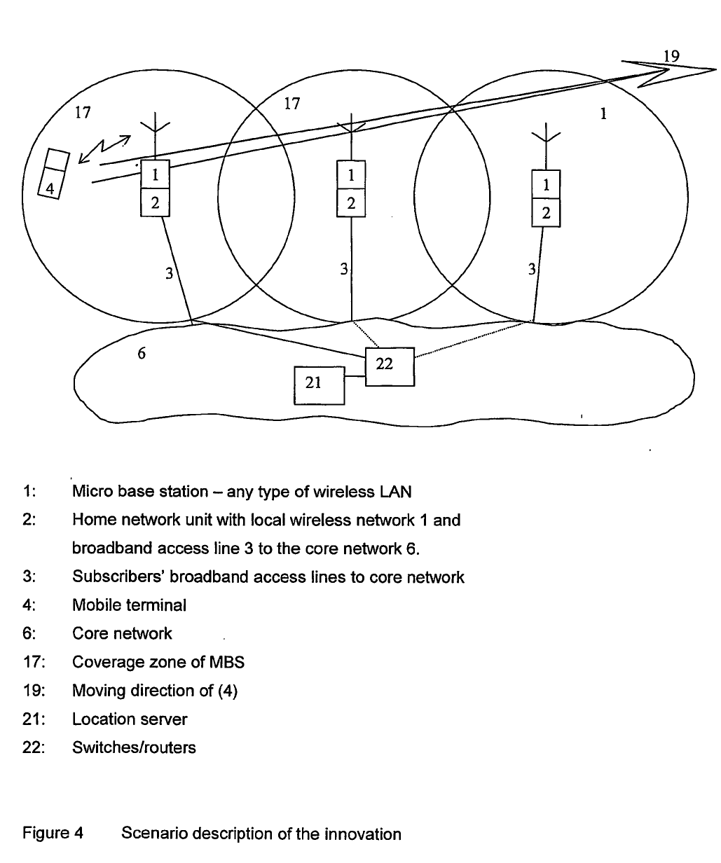

FIG. 4 illustrates a usage scenario in the mobile broadband network according to an embodiment of the invention. Three wireless LANs (Micro base stations) 1 with corresponding Home Network Unit 2 are installed at three different, close by located subscribers (households) of a broadband network. The broadband access lines 3 to the households are realised by use of ADSL/VDSL/optical cable/cable modem or similar. The micro base stations 1 are based upon some kind of wireless LAN technology, for instance WLAN (IEEE 802.11x) used as a home network, connecting different domestic devices such as PCs, TVs, printers, servers, etc. The three wireless LANs partly overlap each other. Since the stationary users seldom neither subscribe to the complete capacity of an access line, nor utilises all subscribed capacity of the access lines and their micro base stations, there will normally exist spare capacity free for casual users. This spare capacity is therefore opened up for public use. Thus, a mobile user with a mobile terminal 4 entering from left in FIG. 4, can be connected to the legacy network via the stationary users micro base station 1, the Home Network Unit 2 and the broadband access line 3. When the user leaves the first coverage zone 17 and enters the next, the connection to the legacy network is handed over from one Home Network Unit 2 to the next. The required mobility issues are solved by implementing appropriate protocols for seamless mobility, hand-over procedures, roaming between different broadband service providers, eventually also roaming between private owners of broadband access lines. Quality of service guarantees, security and authentication and charging features are also part of the concept.

The following bandwidth resources are required to realise a mobile broadband network according to the invention:
1. Free capacity of existing customers' wireless LANs as ‘micro base stations’ (MBS) in the network
2. Free capacity of the subscribers' broadband access lines to the fixed network as feeder lines to the above MBSs. The free capacity may consist of
   The un-subscribed part of the physical realisable capacity of these lines
   The instantaneous and un-used part of the subscribed capacity
   Already allocated bandwidth that can be release through priority mechanisms

Free Capacity of Wireless LANs

An objective of the invention is that casual passing mobile users are offered access to the fixed broadband network via wireless LANs installed at the subscribers' premises in the said network. The wireless LAN technology to be used is not specified. The following brief evaluation is based upon general information about wireless LAN technologies.

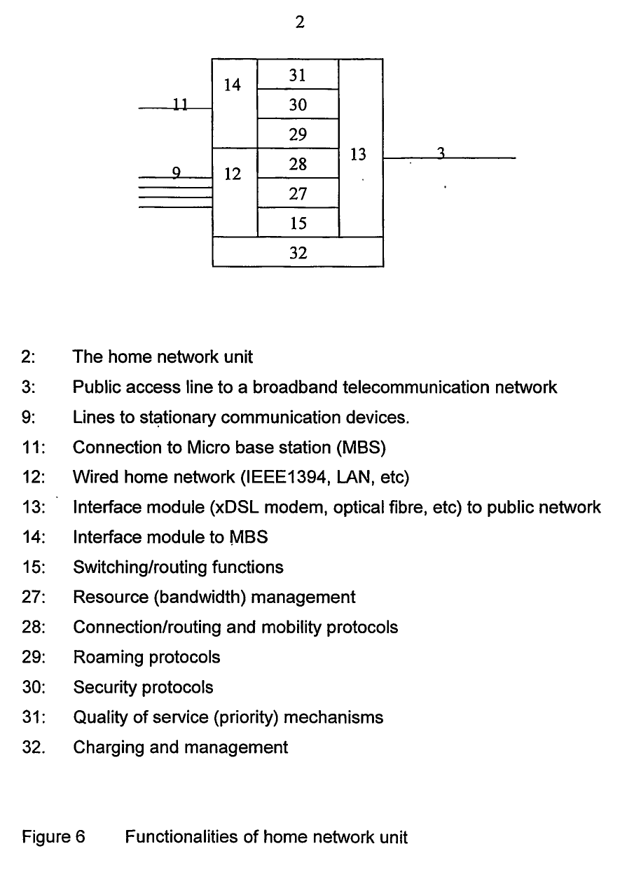

It is the intention that the stationary users shall have priority to the wireless LAN unless other arrangements are valid. The priority mechanisms are performed by module 31 of FIG. 6 below. Encryption algorithms must be deployed to ensure privacy over the air.

The capacity offered to the casual passing users is limited to the maximal capacity of the wireless LAN at a given distance from its base station. At an output power of 100 mW such wireless technologies have a nominal reach of about 30 metres (54 Mbit/s) or 100 metres at lower speed. However, due to error correction algorithms, etc, the net capacity is only about 50% of this, i.e. the maximal capacity that can be offered to mobile users is less than 25 Mbit/s dependent on distance and traffic load.

Free Capacity of Subscribers Broadband Access Lines

Allocation of Unsubscribed Capacity

A second objective of the invention is the use of un-subscribed bandwidth of broadband access lines. The physical access lines have often more transmission capacity than the capacity offered to and subscribed by the users. This un-used capacity is sometime unavailable both for the broadband operator as well as for the users due to the technical realisation of network components. This is particular relevant for access lines based upon DSL technologies (Digital Subscriber Line). In the case of ADSL (Asymmetrical DSL), a modem technology which is widely used today, the subscribers often subscribe for less than 1 Mbit/s downstream capacity, while the modem itself may have downstream capacity of 3-8 Mbit/s. Commercial equipment today does not have the ability to make this wasted capacity (2-7 Mbit/s wasted capacity) available neither for the operator nor for subscribers, even though it from a technical point of view easily can be done. Functions of the Home Network Unit (module 27 of FIG. 6) perform this feature.

The same evaluation can be done also for other types of technologies. An optical cable has near un-limited bandwidth, only restricted by other telecommunication equipment. Only a fraction of the physical realizable bandwidth is used. The far greatest part is wasted. Due to the hierarchical structure of the multiplexer systems, the same consideration can be done in this case. If a user needs a capacity of 50 Mbit/s for communication purposes, he will normally have to order a capacity of 155 Mbit/s due to the hierarchical structure of the systems as mentioned above. 105 Mbit/s is wasted capacity, which theoretically can be used for other purposes.

Policy Managed Allocation of the Subscribed Bandwidth

A user will seldom use all the capacity he has subscribed for. If the subscription is 1 Mbit/s, and he at a certain moment time only uses 300 kbit/s, the remaining 700 kbit/s can be resold to casual passing users. However, in order to resell this capacity to other users, the terms must be defined in an agreement between the stationary user and the broadband provider. The Home Network Unit, module 27, performs this function.

Released Capacity Through Priority Mechanisms

In general it is natural to agree that the stationary users shall have the highest priority to the available resources of the wireless LAN and the corresponding broadband access line. However, there are cases where this is not natural. If a casual passing user, which is running an application with certain requirements to bandwidth and transmission delays, enters a coverage zone unable to take over the connection, it may be rational to reduce the performance of stationary user's running low-priority services in order to release sufficient capacity for the mobile user. Such priority mechanisms are performed by module 31 of FIG. 6.

Functionalities of the Home Network Unit

The main functions performed by The Home Network are:
Routing/switching connections over the physical interfaces; the public broadband access line, the wireless LAN and the wired home network
Resource management to keep track with the usage of all available bandwidth resources, i.e. allocation of
   Bandwidth in the wireless LAN
   Unsubscribed bandwidth over the public access line
   Policy managed subscribed bandwidth over the public access line
   Bandwidth released through priority mechanisms
Perform seamless mobility and hand-over procedures
Realise roaming between different operators and between different owners of wireless LAN and access lines
Perform access control, authentication and security procedures
Comply with quality of service targets
Implement required charging and management functions

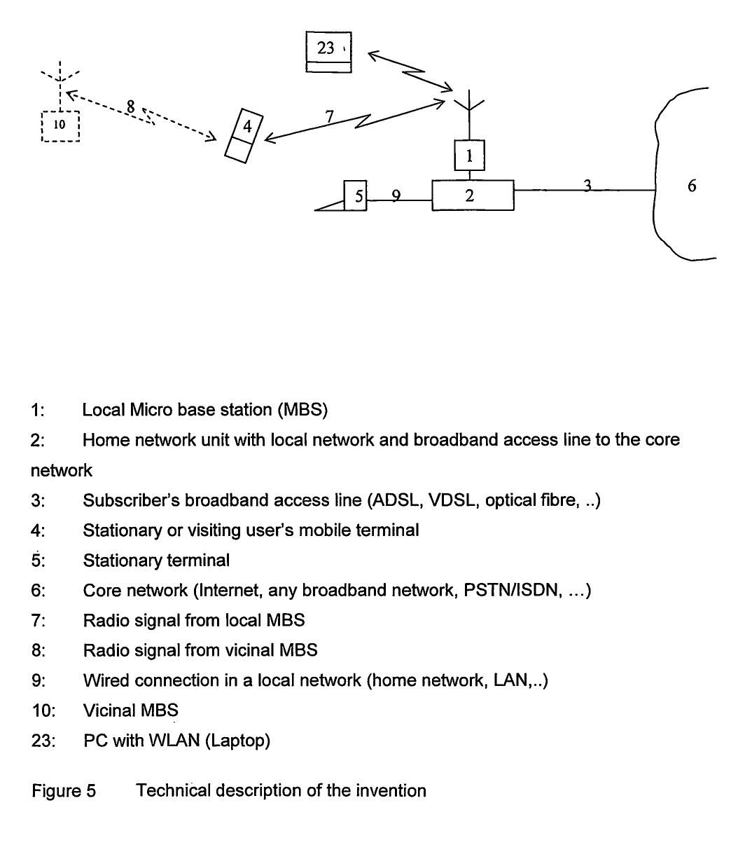

FIG. 5 illustrates a Home Network Unit 2 connected to a broadband network 6 over a broadband access line 3. The stationary user is visualised by a terminal 5, which is connected to a local network over a fixed wired line 9. A wireless LAN base station, hereinafter called “Micro base station (MBS)” 1 is integrated with 2. A stationary terminal 5, for instance a printer, owned by the stationary user, is connected to the Home Network Unit over a wired connection 9. The stationary user also possesses a PC with a wireless LAN interface card 23, which is included in the network. The scenario indicated in this figure depicts that the stationary user can use the printer 5 from his PC 23 and communicate with the public network 6 simultaneously as a mobile user 4 is using spare capacity of the MBS 1 and the access line 3 to the core network 6. An aspect of the invention is that the local devices, in this case the PC 23 and the printer 5, shall not be made available for the mobile user unless the stationary and the mobile users are members of the same P2P or an Ad Hoc network. A main objective is to separate the private sphere from the public sphere, thus the stationary user is unaware of any mobile users who are passing. The mobile user on his side shall be unaware of the identity of the stationary users he is visiting. FIG. 5 further indicates that the mobile user 4 also is covered by the vicinal base station 10, over which he can be connected to the core network, if for instance, the bandwidth offered by Home Network Unit 2 is insufficient.

The functionalities needed to implement a broadband mobile network according to this invention, will normally be performed by different network components. For instance, a function that is initiated by the Home Network Unit will have its counterpart in other devices in the public access and core network. The following description of the FIG. 6 will mainly focus on high-level functions needed to implement the invention, and not go into details on how and where they are performed. Most of them are known features present in many data and telecommunication networks, and are not peculiarities of the invention.

FIG. 6 shows a functional drawing of the Home Network Unit 2. The different modules functions as follows:

Module 15 contains the routing/switching functions. This module, which may be based upon IP (Internet Protocol) or ATM (Asynchronous Transfer Mode), performs traffic routing/switching between the physical interfaces, i.e. between the public access line, 13/3, the micro base station, 14/11 and the wired home network, 12/9. The module for connection/routing and mobility protocols, 28 controls module 15.

Module 27 performs resource management, i.e. keeps track of the total available bandwidth, the usage of bandwidth and the resulting free bandwidth on each of the physical interfaces, 12, 13 and 14. The module ensures that the stationary user is given priority to the bandwidth he has subscribed to according to the contract with the service and network provider. The module distinguishes between the bandwidth allocated by the stationary subscriber and the bandwidth offered to public users. The public offered bandwidth might be composed by the part of
The physical available bandwidth not subscribed by the stationary user
The traffic load dependent part of the subscribed bandwidth, which instantaneously not is used by the stationary subscriber
Eventually bandwidth allocated to the stationary user, but due priority rules and contractual agreements between the stationary user and the network provider, can be released and re-allocated to mobile users.

The module receives information from module 28, Connection/routing and mobility protocols, which informs about establishment and termination of routes/connections and the corresponding involved bandwidth.

Module 28, Connection/routing and mobility protocols runs the necessary protocols needed to establish, to perform seamless mobility and hand-over procedures and to terminate routes/connections in the network. These protocols are defined by standards issued by a number of international standardisation bodies like ETSI (European Telecommunication Standardisation Institute), ITU (International Telecommunication Union), IETF (Internet Engineering Task Force) and many others.

Module 29, Roaming protocols perform the procedures that are needed when users want to use telecommunication resources owned by other service- and network providers than the ones each individual user has agreements with. For instance, when a mobile user moves from MBS1 (Micro base station) owned by network provider A to MBS2 owned by network provider B. The protocols execute the contract, which is ruling the commercial agreement between them. Roaming protocols are also activated during authentication processes.

Module 30, Security protocols perform authentication, access control of users entering the coverage zone of the MBS and data protection mechanisms. A user initiating a communication session must authenticate him to the service and network providers he subscribes to, before the connection can be established and the requested service is offered. If the session initiation happens in zone covered by another network provider, the roaming protocols, module 29, will mediate the authentication procedure. The protocols perform encryption of sensitive data used by these procedures to avoid illegal intrusion and interception.

Module 31, Quality of service (priority) mechanisms contains functions, which ensure that the services provided to the users comply with relevant requirements. For instance, voice communication is sensitive to data transmission delay and bandwidth limitations and relatively insensitive to transmission errors. Data communication on the other side, often accepts delay and bandwidth restrictions, but is sensitive to transmission errors. Priority and queuing mechanisms is used to give priority to voice communication, while error correction protocols are used to protect data.

Module 32, Charging and management contains functions related to the technical handling and maintenance of the unit, performance monitoring and usage monitoring to support charging functions needed by accounting reasons.

Module 13, Public network interface performs the signal conditioning needed to transfer signals over the physical line (3) to the public network. If the physical line is a telephone cable, the conditioning function will be performed by an xDSL modem. For an optical cable it is an optical interface, and for a wireless solution it would have been some kind of wireless interface.

Module 12, Wired home network performs switching/routing of local traffic over the wired in-house network (9). There exists many different protocols and standards for such networks, for instance IEEE 1394 (Firewire), Ethernet, HomePNA, etc.

Module 14 is the interface to the Micro base station (MBS), which in this figure is excluded, but could be an integral part of the Home Network Unit 2.

Re-using existing wired and unwired infrastructures represents an important opportunity to establish a broadband mobile network at much lower cost than any known alternative. Since the infrastructure exists or is presently being established, a broadband mobile network may be realised much earlier than if a new, dedicated network infrastructure has to be built.

The idea of opening up the wireless LANs and the access lines is a new concept and a brilliant way to establish a broadband mobile/nomadic network with potentially 100% coverage in urban areas and spot-wise coverage in other areas.

By establishing a network infrastructure based upon the invention, installation of communication devices in the stationary customers' premises will not be restricted by their respective wireless LANs coverage zones. The subscribers may as well connect a device on locations better covered by neighbour's wireless LAN than by their own. With other words, the subscribers will experience an almost location-independent world. The stationary users may be located anywhere without restriction, and the mobile user may move nearly unrestricted around.

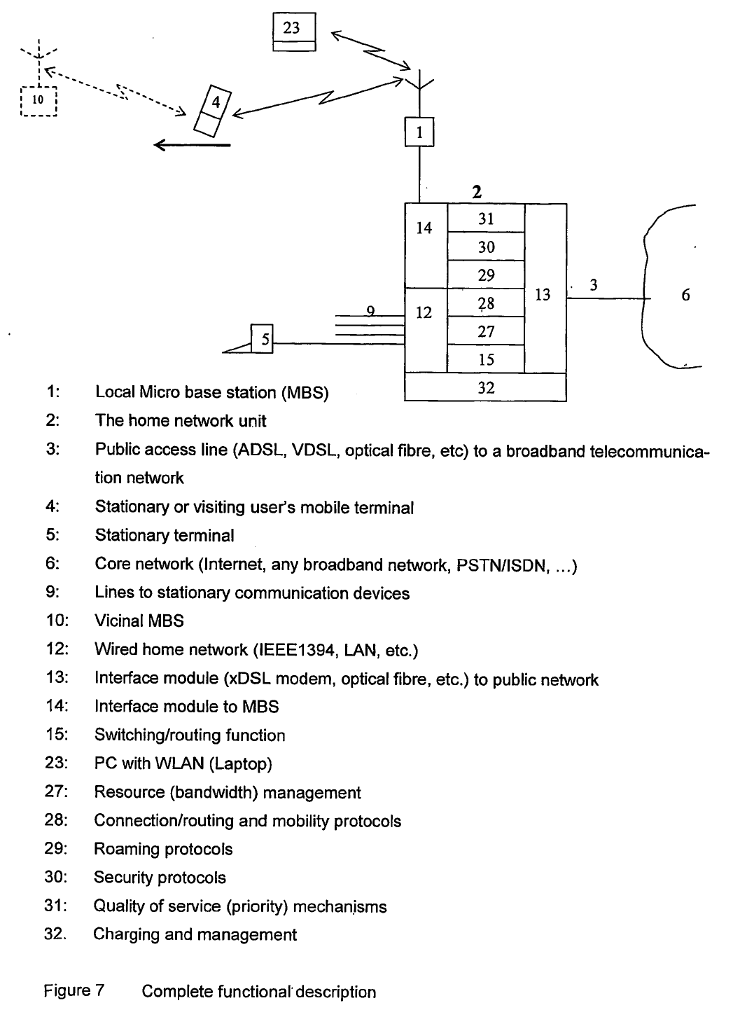

FIG. 7 shows the same scenario as shown in FIG. 5, but now enhanced with the function modules of FIG. 6. A very simplified description follows.

A mobile user 4 has entered the coverage zone of the micro base station 1. While sensing radio coverage, the security module 30 performs access control and authentication. If module 30 does not recognize the mobile user 4, a request from module 29, Roaming protocols, will be sent over the public access line, 13/3 to its counterparts in the network to find out where the user belongs. When the user is recognized, connection set-up, 28, procedures are initiated. Resource management module, 27, and the Quality of service mechanisms, 31, are involved in these procedures to check whether there is bandwidth available on all sections from the mobile user and to the destination, and if the requested quality can be guaranteed. If all these procedures succeed, the Routing/switch module, 15, will establish the communication route through the Home Network Unit 2. Module 32, Charging and management notifies that a communication session from user 4 to a requested service, for instance Internet, has been initiated, and the agreed charging algorithms start.

In an additional scenario, a connection between the wireless Laptop 23 and the printer (stationary terminal 5) shall be established. Since both devices are connected to the same wireless LAN, pure Ad Hoc protocols can be used to establish the connection between them. Alternatively, the Home Network Unit may act as a server for the two clients, the Laptop and the printer. In both cases the security module 30 must authenticate the Laptop 23 and the resource module 27 must to update resource usage.

When the mobile user 4 enters inside the reach of the vicinal MBS 10, roaming and security procedures are activated in order to authenticate the user in the vicinal MBS 10. Upon success, the connection is established by involving the same modules as explained above. The mobile user is finally transferred to the new network segment and all resources of the first Home Network Unit 2, are released and made available for other users.

Having described embodiments of the invention it will be apparent to those skilled in the art that other embodiments incorporating the concepts may be used. These and other examples of the invention illustrated above are intended by way of example only and the actual scope of the invention is to be determined from the following claims.

1. Method of providing a public, wireless broadband mobile service by upgrading a fixed, broadband access network comprising installing home network means at subscriber premises of said fixed network, the home network means comprising at least a wireless local area network (LAN) and a broadband access line to the fixed broadband network, wherein the wireless LAN functions as an access medium for casual passing mobile terminals and for wireless terminals and devices of said fixed subscribers.

2. Method according to claim 1,
characterized in dividing a bandwidth of the wireless LAN and the broadband access line of a fixed subscriber into respectively at least two separate channels, wherein a first channel is used by the fixed subscriber and a second channel is made public available for casual passing mobile terminals.

3. Method according to claims 1 or 2,
characterized in dynamically dimensioning the at least two channels dependent on fixed subscriber's instantaneous traffic in the wireless LAN and over the broadband access line, wherein a remaining bandwidth is made available for passing mobile terminals.

4. Method according to claims 2 and 3,
characterized in that the remaining bandwidth/second channel may include the portion of the physical realisable bandwidth not subscribed for by the fixed subscribers, the portion of the bandwidth subscribed for, but instantaneously unused by the fixed subscriber and the bandwidth that may be released due to priority mechanisms implemented in the network.

5. Method according to claim 1,
characterized in that the home network means and the public broadband network perform security and authentication functions securing the fixed subscriber and the passing mobile terminals against tapping and illegal use of said broadband network.

6. Method according to claim 1,
characterized in providing protocols in the home network means and in said fixed network for performing mobility, handover and roaming procedures.

7. Digital, mobile broadband network providing public mobile or nomadic broadband services based on an existing fixed, broadband access network with a number of subscribers possessing a home network means comprising at least a wireless local area network (LAN) and a broadband access line to a public, fixed broadband network, wherein the wireless LAN functions as an access medium for casual passing mobile terminals as well as for local wireless terminals of the fixed subscriber.

8. Broadband network according to claim 7,
characterized in that the bandwidths of the wireless LAN and the broadband access line are divided in at least two separate channels, a first channel being used by the subscriber and a second channel public available for the casual passing mobile terminals.

9. Broadband network according to claim 8,
characterized in that the at least two channels are dynamically dimensioned dependent on fixed subscriber's instantaneous traffic in the wireless LAN and over the broadband access line, wherein a remaining bandwidth is made available for passing mobile terminals.

10. Broadband network according to claims 8 and 9,
characterized in that the channel for passing mobile terminals comprising the portion of the physical realisable bandwidth not subscribed for by the fixed subscriber, the portion of the bandwidth subscribed for, but instantaneously unused by the fixed subscriber and the bandwidth that may be released due to priority mechanisms implemented in the network.

11. Broadband network according to claim 7,
characterized in that the home network means and the broadband access network perform security and authentication functions securing the fixed subscriber and the passing mobile terminals against tapping and illegal use of said broadband network.

12. Broadband network according to claim 7,
characterized in that the home network means and said fixed broadband access network comprising protocols for performing mobility, handover and roaming procedures.

13. Home network device providing public mobile or nomadic broadband services in an existing fixed, broadband access network comprising a number of subscribers, wherein said device comprising:
a. A wireless LAN providing local, wireless broadband communication for the subscriber of the fixed, broadband network and broadband communication for casual passing mobile terminals,
b. A broadband access line connected to the fixed broadband network,
c. Appropriate traffic and control functions needed for wireless mobile communication.

14. Home network device according to claim 13, comprising a resource management system and multiplexer means dividing the physical available bandwidths of the wireless LAN and the broadband access line into at least two channels, a first channel to be used by the fixed network's subscriber and a second public channel available for the casual passing mobile terminals.

15. Home network device according to claim 14, comprising a resource management system performing dynamical bandwidth allocation to the casual passing mobile terminals dependent on the fixed subscriber's instantaneous traffic load on the wireless LAN and over the broadband access line.

16. Home network device according to claim 13, comprising switching/routing means passing traffic to and from the broadband access network and the different wireless terminals located within the reach of the wireless LAN.

17. Home network device according to claim 13, comprising protocol means providing seamless mobility and handover procedures for maintaining the connection to the fixed broadband access network for a mobile terminal passing subscriber wireless LANs.

18. Home network device according to claim 13, comprising protocol means providing roaming between different fixed, network operators, P2P/Ad Hoc operators and individual subscriber LANs.

19. Home network device according to claim. 13, comprising function means supporting the broadband network's management and charging requirements.

20. Use of a home network device comprising at least a wireless LAN and a subscriber's broadband access line to a public broadband access network providing local wireless communication for the fixed subscriber and mobile broadband services to casual passing wireless terminals.
